(19) United States
(12) Patent Application Publication
(10) Pub. No.: US 2016/0309264 A1
(43) Pub. Date: Oct. 20, 2016

(54) Acoustic Apparatus Using Flex PCB Circuit With Integrated I/O Fingers

(71) Applicant: Knowles Electronics, LLC, Itasca, IL (US)

(72) Inventors: Usha Murthy, Lisle, IL (US); Richard Scheleski, Naperville, IL (US); Dean Badillo, Schaumburg, IL (US)

(21) Appl. No.: 15/093,025

(22) Filed: Apr. 7, 2016

Related U.S. Application Data
(60) Provisional application No. 62/147,044, filed on Apr. 14, 2015.

(51) Int. Cl. H04R 19/01; H04R 19/00; H04R 3/00

(52) U.S. Cl. CPC H04R 19/016; H04R 3/00; H04R 19/005

(57) ABSTRACT

A microphone assembly includes a housing having an interior with a front volume and a back volume. The housing has an acoustic input port coupling the front volume to an exterior of the housing. An acoustic sensor is disposed at least partially within the interior of the housing. At least a portion of the acoustic sensor is disposed at an interface between the front volume and the back volume. The acoustic sensor has an electrical signal output. A circuit board is disposed at least partially within the back volume of the housing and has a conductive member and an electrical contact. The circuit board also has a first portion carrying a first portion of the conductive member, and a second portion of the conductive member extending from the first portion of the circuit board toward the acoustic sensor. The second portion of the conductive member is electrically connected to the electrical signal output of the acoustic sensor.

### CROSS-REFERENCE TO RELATED APPLICATION

This patent claims benefit under 35 U.S.C. §119 (e) to U.S. Provisional Application No. 62/147,044 entitled “Acoustic Apparatus Using Flex PCB Circuit With Integrated I/O Fingers” filed Apr. 14, 2015, the content of which is incorporated herein by reference in its entirety.

### TECHNICAL FIELD

This disclosure relates to construction of electret microphones and, more specifically, to the circuit board used in these devices.

### BACKGROUND

A microphone in general receives sound energy and converts the sound energy into an electrical signal. Various types of microphones have been in use over the years. One such type is electret microphone. The electret microphone consists of a rigid back plate and a metalized polymer diaphragm forming a capacitive sensor with a permanently charged dielectric layer known as electret on either the back plate or diaphragm providing a bias to the sensing element. It is also desirable for processing electronics circuits to be located near the sensor and in the same housing to minimize interference to the high impedance signal from the sensor.

In some previous approaches, special ceramic hybrid microcircuits are used to mount signal processing electronics and to provide an interconnection between the sensing element and the electronics. One of the reasons for using a ceramic hybrid microcircuit is its ability to support semi/fully automatic micro weld operations such as wire bonding and/or wire welding processes required for attaching special thin wires and/or ribbons to provide interconnections between sensor and the processing electronics and to the outside world. A thickness of the ceramic substrate used in these circuits is decided by the handling ease of the brittle ceramic material during circuit realization processes and requirements of micro-weld or wire bonding operations.

The hybrid microcircuit, in general, is housed in the back volume part of microphone in order to keep it close to the sensor element and reduce interference to the high impedance signal from sensor. Since the back volume plays a major role in determining a microphone's acoustic performance, the overall size of the hybrid microcircuit housed within the back volume not only influences acoustic performance but also limits the size of the miniature electret microphone.

Some of the other approaches using circuit boards (other than ceramic based boards) require special fixtures in order to facilitate wire bonding or micro gap welding to be effective. However, these fixtures are not always effective and result in increased cost of manufacturing.

Yet another previous approach calls for realization of integrated sensor and circuit board elements in lieu of more the modular and efficient approach of building and testing electronics separately.

All of the problems listed above have resulted in some user dissatisfaction with previous approaches.

### BRIEF DESCRIPTION OF THE DRAWINGS

For a more complete understanding of the disclosure, reference should be made to the following detailed description and accompanying drawings wherein:

FIG. 1 is a perspective drawing of a microphone assembly;

FIG. 2 is a cross sectional side view of a microphone assembly of FIG. 1 along the A-A axis; and

FIG. 3 is a perspective view of the circuit portion of the microphone assembly of FIG. 1 and FIG. 2.

Those of ordinary skill in the art will appreciate that elements in the figures are illustrated for simplicity and clarity. It will be appreciated further that certain actions and/or steps may be described or depicted in a particular order of occurrence while those of ordinary skill in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Approaches are provided to realize an electret (or other type of) microphone assembly that eliminates the use of a ceramic substrate and wire bonding/micro welding of interconnect wires/ribbons in the assembly construction. The approaches use a flex or Rigid-flex circuit to support signal processing electronics with integrated stamped finger(s) carrying a conductive trace to couple electronics to the sensor. The sensor in this case comprises a diaphragm and charge plate.

The present approaches are simple to use, provide more back volume, improve microphone performance and pave the way for the realization of miniature electret microphone profiles. Although the approaches described herein are for electret microphones, it will be appreciated that these approaches could be used with other types of microphones such as Micro Electro Mechanical System (MEMS) microphones as well.

Advantageously, the present approaches provide for increased microphone reliability. In one example, the use of a Flex or Rigid-Flex circuit board with integrated input/output (I/O) fingers reduces number of interconnection joints, approximately by half. Reduced number of interconnection joints means reduced probability of failure modes and increased reliability.

In addition, the present approaches enable thinner electret microphones to be constructed. In one aspect, this is brought about by the elimination of micro welding processes, which allows substrate thickness to be reduced by nearly 60% in some examples. The use of circuits that have reduced substrate thicknesses increases back volume resulting in improved microphone performance. For example, the sensitivity of the microphone may be increased or otherwise improved. Other performance improvements are also possible.

The present approaches also result in cost reduction in various ways. Primary cost reduction is brought about by the elimination of wire bonding and micro welding processes which involves use of high cost gold wires and/or gold coated ribbons, dedicated machinery and skilled labor. In addition, elimination of a process step increases number of units produced per hour resulting in lower production cost. Finally, replacing the higher cost specialized ceramic-based hybrid circuit with an industry standard Flex or Rigid-Flex printed circuit board (PCB) circuit also serves to reduce the cost.

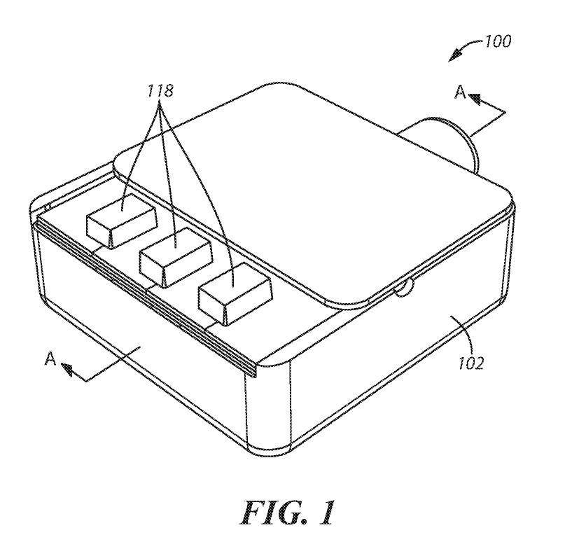

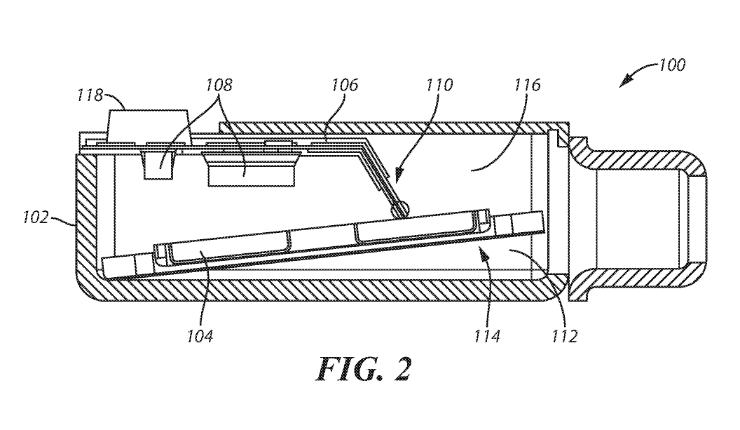

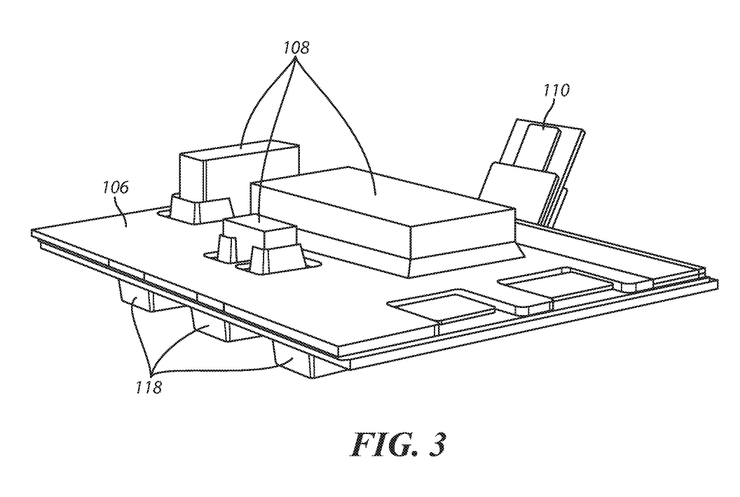

Referring to FIG. 1, FIG. 2 and FIG. 3, one example of a microphone 100 is described. The microphone 100 includes a housing 102, a sensor 104 (including a back plate and a diaphragm), a flex circuit board 106 (that includes circuits 108 and a finger portion 110). Sound enters the microphone through a port 112. The sensor 104 converts the sound energy into electrical signals that are representative of the sound energy. The sensor 104 separates the microphone interior into a front volume 114 and a back volume 116.

As mentioned, the sensor 104 includes a diaphragm and a back plate. A charge differential is created by the back plate and the diaphragm, so that the combination of the two elements acts as a capacitor. As the diaphragm moves by the changing sound pressure, electrical potential varies and creates an electrical current and voltage that is representative of the sound energy that is received.

The flex circuit board 106 is configured to receive electrical circuits such as the electrical circuitry 108 and support terminal pads 118 for interconnection to outside circuitry along with a stamped flexible finger 110 carrying a conductive trace for interfacing with sensor.

The electrical circuitry 108 may include any type of electrical processing circuits such as application specific integrated circuits (ASICs). Additionally, the Flex or Rigid-Flex circuit board 106 may include passive components such as capacitors and resistors used for shaping microphone response.

In another embodiment of the approach, terminal pads 118 can also be realized as stamped flexible fingers for ease of microphone assembly at the user end.

The Flex or rigid-Flex circuit board 106 may be constructed of multiple layers of material such as conductive and insulating layers of material. It may include embedded capacitors and/or resistors also.

Stamped finger portion 110 of the Flex or Rigid-Flex circuit board 106 may be designed to be of specific thickness and width depending on bending requirements. It may or may not be of the same thickness as the rest of board.

The finger portion 110 of the board 106 may be secured to the sensor by any appropriate attachment mechanism or approach such as by conductive glue or some other fastening or attachment approach to receive a signal from the sensor and feed it to the circuit 108 assembled on the board 106, without distortion.

Once the electrical circuits 108 have performed their processing functions, the electrical signal is sent to the terminal pads 118. The pads 118 may be coupled to other external circuitry such as a hearing aid, cellular phone, personal computer or tablet (to mention a few examples) to perform additional processing functions and receive power.

It will be appreciated that the relatively a thin (as compared to ceramic boards) Flex or Rigid-Flex circuit board will increase the amount of back volume 116 (for any given assembly volume or size) that is available in the microphone 100. It will also be understood that the increase in the back volume 116 will advantageously result in improved microphone performance.

As compared to previous approaches, the coupling of the flex circuit board 106 to the sensor can be accomplished easily, with relatively unskilled personnel, and quickly. As such, the approaches described herein are extremely cost effective to use and increase the number of microphones that can be constructed or manufactured over a given time period.

Preferred embodiments are described herein, including the best mode known to the inventor(s). It should be understood that the illustrated embodiments are exemplary only, and should not be taken as limiting the scope of the appended claims.

What is claimed is:

1. A microphone assembly comprising:
a housing having an interior with a front volume and a back volume, the housing having an acoustic input port coupling the front volume to an exterior of the housing;
an acoustic sensor disposed at least partially within the interior of the housing, at least a portion of the acoustic sensor disposed at an interface between the front volume and the back volume, the acoustic sensor having an electrical signal output;
a circuit board disposed at least partially within the back volume of the housing, the circuit board having a conductive member and an electrical contact, the circuit board having a first portion carrying a first portion of the conductive member, a second portion of the conductive member extending from the first portion of the circuit board toward the acoustic sensor,
the second portion of the conductive member being electrically connected to the electrical signal output of the acoustic sensor.

2. The microphone assembly of claim 1, the second portion of the conductive member is integrated with the circuit board.

3. The microphone assembly of claim 1, the circuit board including a second portion extending from the first portion of the circuit board, the second portion of the circuit board carrying the second portion of the conductive member.

4. The microphone assembly of claim 3, the second portion of the circuit board is a flexible finger extending from the first portion of the circuit board at an angle.

5. The microphone assembly of claim 4, the acoustic sensor is an electret microphone including a back plate and a diaphragm, the back plate and the diaphragm form a portion of the interface between the front volume and the back volume, the electrical signal output of the acoustic sensor disposed in the back volume of the housing.

6. The microphone assembly of claim 1, the acoustic sensor is a condenser microphone including a back plate and a diaphragm, the back plate and diaphragm constitute a portion of the interface between the front volume and the back volume.

7. The microphone assembly of claim 1 further comprising an integrated circuit disposed within the interior of the housing, the integrated circuit coupled to the electrical contact of the circuit board and to the conductive member of the circuit board, wherein the acoustic sensor produces an electrical signal in response to acoustic energy entering the cavity via the acoustic input port, and the integrated circuit provides a processed signal at the electrical contact.

8. The microphone assembly of claim 3, the circuit board is a flex circuit board and the electrical contact is accessible from an exterior of the housing.

9. The microphone assembly of claim 1, the back volume of the housing includes an opening, and the electrical contact is disposed on a portion of the circuit board disposed in the opening, wherein the electrical contact is accessible from an exterior of the housing.

10. A microphone comprising:
a housing defining an internal cavity;
a sensor disposed in the cavity, the sensor dividing the cavity into a front volume and a back volume;
a port extending through the housing and in communication with the front volume;
a circuit board including a first portion and a second portion, a conductor carried by the first and second portions of the circuit board, the first portion of the circuit board at least partially enclosing the back volume, the first portion of the circuit board including a terminal pad, a portion of the conductor carried by the second portion of the circuit board contacting the sensor,
wherein the sensor produces an electrical signal in response to detecting acoustic energy that enters the cavity through the port, the electrical signal representative of the acoustic energy, the electrical signal conducted from the sensor to the circuit board via the conductor.

11. The microphone of claim 10, wherein the terminal pad is accessible on an exterior of the housing.

12. The microphone of claim 10, wherein the circuit board includes an integrated circuit or at least one passive electrical component.

13. The microphone of claim 10, wherein the sensor includes a diaphragm and a back plate.

14. The microphone of claim 10, wherein the circuit board is a flex circuit or a rigid-flex circuit.

15. The microphone of claim 10, wherein the conductor of the circuit board is secured to the sensor by conductive glue.

16. A microphone comprising:
a housing that defines an internal cavity;
a sensor including a diaphragm and a back plate disposed in the cavity, the sensor dividing the cavity into a front volume and a back volume;
a port extending through the housing and in communication with the front volume;
a circuit board including a first portion and a second portion, the first portion of the circuit board including a first conductor coupled to a terminal pad, the second portion of the circuit board extending at an angle from the first portion of the circuit board, the second portion of the circuit board including a second conductor in electrical contact with the sensor;
an integrated circuit coupled to the first conductor and to the second conductor,
wherein the sensor produces an electrical signal in response to acoustic energy that enters the cavity via the port, the electrical signal conducted from the sensor to the integrated circuit via the second conductor, the electrical signal being processed by the integrated circuit to create a processed electrical signal, the processed electrical signal being conducted to the terminal pads via the first conductor.

17. The microphone of claim 16, wherein the terminal pad is disposed on an exterior of the housing.

18. The microphone of claim 16, wherein the circuit board is a flex circuit or a rigid-flex circuit.

19. The microphone of claim 16, wherein the second conductor is secured to the sensor by conductive glue.

20. The microphone of claim 17, wherein the first portion of the circuit board is disposed at least partially within the housing interior.
